(19) United States
(12) Patent Application Publication
(10) Pub. No.: US 2020/0387928 A1
(43) Pub. Date: Dec. 10, 2020

(54) SYSTEMS AND METHODS FOR PERSONALIZED RETARGETING

(71) Applicant: XMPie (Israel) Ltd., Netanya (IL)

(72) Inventors: Gilad MADMONI, Netanya (IL); Yaron Tomer, Petah Tikva (IL); Amit Cohen, Herzeliya (IL)

(73) Assignee: XMPie (Israel) Ltd., Netanya (IL)

(21) Appl. No.: 16/897,872

(22) Filed: Jun. 10, 2020

Related U.S. Application Data
(60) Provisional application No. 62/859,229, filed on Jun. 10, 2019.

(51) Int. Cl. G06Q 30/02; G06Q 30/06; G06F 16/9535; G06F 16/23

(52) U.S. Cl. CPC G06Q 30/0255; G06F 16/2365; G06F 16/9535; G06Q 30/0621

(57) ABSTRACT

A personalized retargeting method is provided. The personalized retargeting method involves receiving a first data set that includes one or more data items indicating options that are unique to a user for a customized product. A second data set that is similar to the first data set is transmitted to a retargeting platform for display with a banner when the user visits a second website. Once the first data set is validated by the retargeting platform, then the first data set is transmitted to the retargeting platform for display with a banner when the user visits the second website.

### CROSS REFERENCE TO RELATED APPLICATIONS

This application claims priority to U.S. Provisional Patent application No. 62/859,229 filed on Jun. 10, 2019, the entire contents of which are incorporated herein by reference in its entirety, and owned by the assignee of the instant application.

### FIELD OF THE INVENTION

The invention relates generally relates to technology for personalized online retargeting based on an individual's internet actions.

### BACKGROUND OF THE INVENTION

Typically, retargeting (e.g., behavioral remarketing) can be a form of online targeted advertising by which, for example, online advertising is targeted to consumers based on their previous internet actions. Retargeting can include tagging online users by including a pixel within a webpage or email, which can set a cookie in the user's browser. Once the cookie is set, the advertiser may able to show display ads to that user elsewhere on the internet, for example, via an ad exchange.

Dynamic creative (e.g., personalized) retargeting can allow an advertiser to display a banner created during operation of the webpage for a particular consumer based on specific webpages that the user has viewed. For example, if a consumer visits an advertiser's website and browses products A, B and C—when the user subsequently visits a different website, they can be retargeted at the different website with a display banner that features the products A, B and C that or similar products that the user previously viewed.

Current retargeting platforms (e.g., Google Ads) can require website owners to validate content (e.g., data) they want to include in banners during retargeting. The validation can take days. For some website owners it is not practical to validate all of the content to be used for retargeting days before. For example, if the website owner offers a product with custom colors it may not be possible to validate the custom color a particular user creates for the product. In this scenario, a website owner can validate a set of colors and select a color that was previously validated and that is similar to the custom color that was created by the user for use in retargeting, however it is not the exact color the user created.

Therefore, it can be desirable to provide more accurate retargeting, retargeting that is personalized for a particular user.

### SUMMARY OF THE INVENTION

One advantage of the invention can include an ability to present retargeting content to a user that is personalized for the particular use. Another advantage of the invention includes adding additional parameters to the retargeting content so that it can include personalized messages beyond the known technique of banners, e.g. personalized image. Another advantage of the invention can include an increased probability that the user returns to the abandoned site.

In one aspect, the invention involves a method for personalized retargeting. The method involves receiving an indication that a user has partially created a customized product at a first website and abandoned the first website. The method also involves receiving, by the computer, a first dataset that includes one or more data items, wherein each of the one or more data items are options that the user selected for the customized product. The method also involves selecting, by the computer, a second dataset from a plurality of predetermined datasets that is similar to the first dataset. The method also involves transmitting, by the computer, the second dataset with a unique user identification to a retargeting platform for display as a banner when the user visits a second website. The method also involves transmitting, by the computer, a request to validate the first dataset to the retargeting platform. The method also involves receiving, by the computer, the first dataset validated from the retargeting platform. The method also involves transmitting, by the computer, the first dataset with the unique user identification to the retargeting platform for display, as a banner, when the user visits the second website or other websites.

In some embodiments, the method involves creating, by the computer, a third dataset that is identical to the second dataset, and transmitting, by the computer, a request to validate the third dataset to the retargeting platform.

In some embodiments, wherein the third dataset is added to the plurality of predetermined datasets. In some embodiments, wherein the first website and the second website are different. In some embodiments, the plurality of predetermined datasets are determined based on typical interactions within the first website.

In another aspect, the invention involves a computer program product for personalized retargeting which when the program is executed causes the computer to receive an indication that a user has partially created a customized product at a first website and abandoned the first website, receive a first dataset that includes one or more data items, wherein each of the one or more data items are options that the user selected for the customized product, select a second dataset from a plurality of predetermined datasets that is similar to the first dataset, transmit the second dataset with a unique user identification to a retargeting platform for display as a banner when the user visits a second website, transmit a request to validate the first dataset to the retargeting platform, receive the first dataset validated from the retargeting platform, and transmit the first dataset with the unique user identification to the retargeting platform for display, as a banner, when the user visits the second website or other websites.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a sequence diagram for personalized retargeting, according to an illustrative embodiment of the invention.

FIG. 2 is a flow chart of a method for personalized retargeting, according to an illustrative embodiment of the invention.

FIG. 3 is a block diagram of a computing device which can be used with embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

In general, the invention involves personalized retargeting. The personalized retargeting can involve pre-validating a group of datasets for retargeting for a particular website. When a user visits a website and selects one or more options, one of the validated dataset from the group of datasets that is closest to the user's selected option(s) can be assigned to the user, even though the validated dataset may not reflect the exact selected options of the user. A dataset that can reflect the selected options can be generated and sent to be validated. When the dataset that reflects the selected options of the user is validated, it can replace the validated dataset that was assigned to the user but that did not reflect the user's exact options.

For example, assume a website can offer users a red or black car, but only the retargeting banner for a black car has been validated. When a user arrives to the website and selects a red car, and then goes to another website, the user is shown an ad for a black car, and a request to the retargeting platform to validate the content for the red car is submitted. When the red car content is validated, the black car retargeting content can be seamlessly replaced with the red car retargeting content.

In another example, assume a website offers home paints to be customized with an exact color value [r,g,b], where 0<=r,g,b<=255. The number of possible colors is over 16 million. A set of default colors can be validated by a retargeting platform in advance. When a user visits the website and selects one color that is not one of the default colors, a default color that is closest to the selected color can be assigned to the user and used as the basis of the retargeting. The selected color can be sent to the retargeting platform for validation, and once validated, the selected color can replace the default color and be used as the basis of the retargeting.

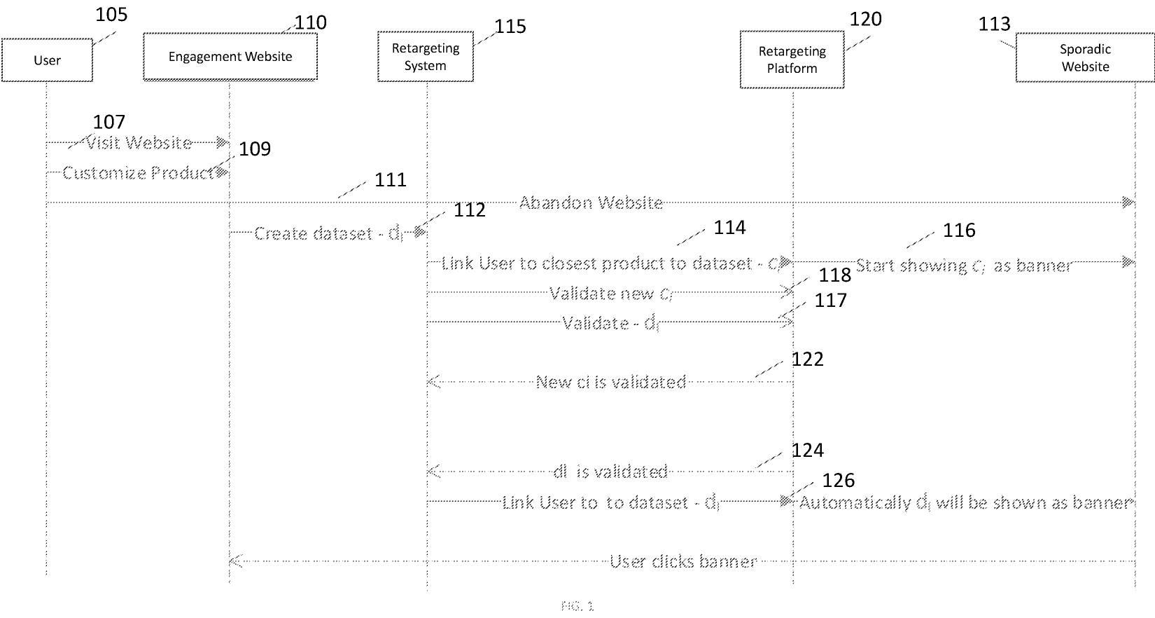

FIG. 1 is a sequence diagram for personalized retargeting, according to an illustrative embodiment of the invention. The sequence can start with a user 105 visiting 107 via the Internet an engagement website 110 (e.g., a car dealership website or a home paint company) and selecting one or more customizable options 109 on the engagement website 110. The user 105 can abandon the website 111 and visit a sporadic website 113 (e.g., a second, third, fourth website).

The engagement website 110 detecting that the user 105 has left the engagement website 110 can create a dataset dᵢ (e.g., for a car agency customization website the dataset can include the selected color, whether a sunroof was elected, whether a Double-Exhaust was selected etc.) e.g., a first dataset, which includes the one or more customizable options that the user selected while on the engagement website 110. The engagement website 110 can send the dataset dᵢ 112 to the retargeting system 115.

The retargeting system 115 can determine a dataset cᵢ (e.g., a second dataset) by selecting one dataset from a group of datasets that is the most similar to the dataset dᵢ. The group of datasets can be datasets that were validated by a retargeting platform 120 that the engagement website 110 uses for retargeting. The retargeting system 110 can determine the similarity between the dataset d₁ and one dataset in the group of datasets by comparisons as are known in the art. For example, for a paint color value, similarity can be determined by finding the smallest difference between the actual color and each color in a palette of colors.

The retargeting system 115 can link the user 105 to the dataset cᵢ and send 114 the dataset cᵢ to the retargeting platform 120, which can then send 116 the dataset cᵢ on the sporadic website 113 to the user 105 as, for example, a banner.

The retargeting system 115 can create a new dataset that is the same dataset as the dataset cᵢ and send 118 it to the retargeting platform 120 to be validated, so that it can replace the dataset cᵢ that was used to be displayed to the user 105. As is known in the art, many retargeting platforms assign unique identifiers to each validated dataset, such that making a copy of a priorly validated dataset is not sufficient. In this manner, the retargeting system 115 can have datasets available for multiple users to be retargeted in parallel.

The retargeting system 115 can send the dataset dᵢ 117 to the retargeting platform 120 to be validated.

The retargeting platform 120 can transmit 122 the dataset cᵢ as validated to the retargeting system 115. The retargeting system 115 can store the dataset cᵢ in the group of datasets. The retargeting platform 120 can transmit 124 the dataset dᵢ as validated to the retargeting system.

The retargeting system 115 can transmit 126 the validated dataset dᵢ to the retargeting platform 120. The retargeting platform 120 can replace the dataset cᵢ for user 105 with the dataset dᵢ. In this manner, the user 105 be retargeted with more personalized options.

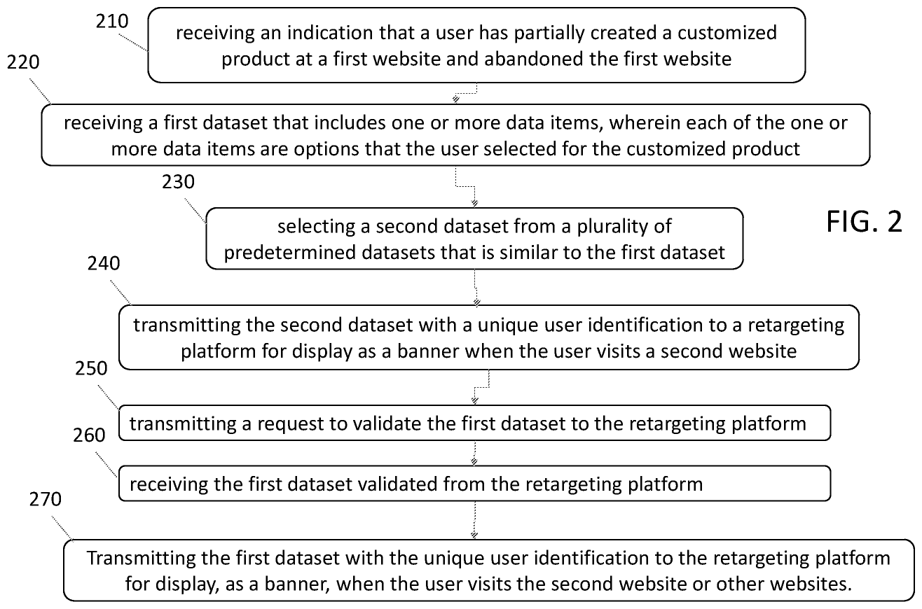

FIG. 2 is a flow chart of a method for personalized retargeting, according to an illustrative embodiment of the invention.

The method involves receiving (e.g., at a retargeting system 115, as described above in FIG. 1) an indication that a user has partially created a customized product at a first website and abandoned the first website (Step 210).

The method also involves receiving (e.g., at a retargeting system 115, as described above in FIG. 1) a first dataset that includes one or more data items (Step 220). The one or more data items can be options that the user selected for the customized product, options received from an input file, options received from another website, or any combination thereof. The first data set can be received from an engagement website that the user visited. The engagement website can be any website that the user selects configurable options on. For example, a car dealership's website, a mortgage broker website, a clothing company website, and/or airline website. For example, in a for an airline website with a frequent flyer program, the airline website program knows it is particular use Jane that logged in, and know her miles, the destinations she prefers etc. The airline system selects the options automatically based on Jane's stored preferences

The method also involves selecting (e.g., at a retargeting system 115, as described above in FIG. 1) a second dataset from a plurality of predetermined datasets that is similar to the first dataset (Step 230). The predetermined datasets can be datasets that the engagement website anticipated user is likely to select and that were validated by a retargeting platform. As is known in the art, some retargeting platforms (e.g., operated by web service providers) can require that retargeting content be validated prior to publishing retargeting content. The validation can take days. An engagement website that has many customizable options may not have validated every permutation of their customizable options. Also, engagement websites can frequently update their content and options, and may not seek validation each and every time their content and options are updated. In some scenarios, the user may select a combination of options on the engagement website that has not been validated. In these scenarios, a dataset can be selected from the predetermined dataset that is similar to the first dataset.

The method also involves transmitting (e.g., at a retargeting system 115, as described above in FIG. 1) the second dataset with a unique user identification to a retargeting platform for display as a banner when the user visits a second website (Step 240). In some embodiments, the banner includes a link to a personalized website.

The method also involves transmitting (e.g., at a retargeting system 115, as described above in FIG. 1) a request to validate the first dataset to the retargeting platform (Step 250). The method also involves receiving the first dataset validated from the retargeting platform (Step 260).

The method also involves transmitting (e.g., at a retargeting system 115, as described above in FIG. 1) the first dataset with the unique user identification to the retargeting platform for display, as a banner, when the user visits the second website or other websites (Step 270).

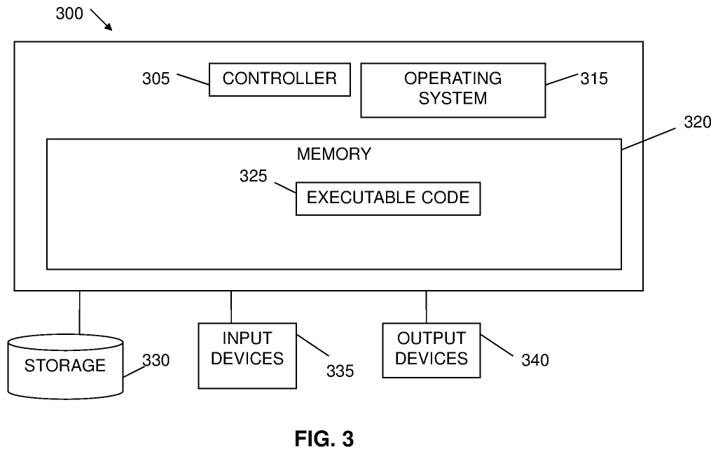

FIG. 3 shows a block diagram of a computing device 300 which can be used with embodiments of the invention. Computing device 300 can include a controller or processor 305 that can be or include, for example, one or more central processing unit processor(s) (CPU), one or more Graphics Processing Unit(s) (GPU or GPGPU), a chip or any suitable computing or computational device, an operating system 315, a memory 320, a storage 330, input devices 335 and output devices 340.

Operating system 315 can be or can include any code segment designed and/or configured to perform tasks involving coordination, scheduling, arbitration, supervising, controlling or otherwise managing operation of computing device 300, for example, scheduling execution of programs. Memory 320 can be or can include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 320 can be or can include a plurality of, possibly different memory units. Memory 320 can store for example, instructions to carry out a method (e.g. code 325), and/or data such as user responses, interruptions, etc.

Executable code 325 can be any executable code, e.g., an application, a program, a process, task or script. Executable code 325 can be executed by controller 305 possibly under control of operating system 315. For example, executable code 325 can when executed cause masking of personally identifiable information (PII), according to embodiments of the invention. In some embodiments, more than one computing device 300 or components of device 300 can be used for multiple functions described herein. For the various modules and functions described herein, one or more computing devices 300 or components of computing device 300 can be used. Devices that include components similar or different to those included in computing device 300 can be used, and can be connected to a network and used as a system. One or more processor(s) 305 can be configured to carry out embodiments of the invention by for example executing software or code. Storage 330 can be or can include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, NN model data, parameters, etc. can be stored in a storage 330 and can be loaded from storage 330 into a memory 320 where it can be processed by controller 305. In some embodiments, some of the components shown in FIG. 3 can be omitted.

Input devices 335 can be or can include for example a mouse, a keyboard, a touch screen or pad or any suitable input device. It will be recognized that any suitable number of input devices can be operatively connected to computing device 300 as shown by block 335. Output devices 340 can include one or more displays, speakers and/or any other suitable output devices. It will be recognized that any suitable number of output devices can be operatively connected to computing device 300 as shown by block 340. Any applicable input/output (I/O) devices can be connected to computing device 300, for example, a wired or wireless network interface card (NIC), a modem, printer or facsimile machine, a universal serial bus (USB) device or external hard drive can be included in input devices 335 and/or output devices 340.

Embodiments of the invention can include one or more article(s) (e.g. memory 320 or storage 330) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with embodiments. In some embodiments the instructions stores on the computer readable medium may be in the form of an installed application and in the form of an installation package.

Such instructions may be, for example, loaded by one or more processors and get executed. For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

What is claimed is:

1. A method for personalized retargeting, the method comprising:
receiving, by a computer, an indication that a user has partially created a customized product at a first website and abandoned the first website;
receiving, by the computer, a first dataset that includes one or more data items, wherein each of the one or more data items are options that the user selected for the customized product;
selecting, by the computer, a second dataset from a plurality of predetermined datasets that is similar to the first dataset;
transmitting, by the computer, the second dataset with a unique user identification to a retargeting platform for display as a banner when the user visits a second website;
transmitting, by the computer, a request to validate the first dataset to the retargeting platform;
receiving, by the computer, the first dataset validated from the retargeting platform; and
transmitting, by the computer, the first dataset with the unique user identification to the retargeting platform for display, as a banner, when the user visits the second website or other websites.

2. The method of claim 1 further comprising:
creating, by the computer, a third dataset that is identical to the second dataset; and
transmitting, by the computer, a request to validate the third dataset to the retargeting platform.

3. The method of claim 2 wherein the third dataset is added to the plurality of predetermined datasets.

4. The method of claim 1 wherein the first website and the second website are different.

5. The method of claim 1 wherein the plurality of predetermined datasets are determined based on typical interactions within the first website.

6. A computer program product for personalized retargeting which when the program is executed causes the computer to:
receive an indication that a user has partially created a customized product at a first website and abandoned the first website;
receive a first dataset that includes one or more data items, wherein each of the one or more data items are options that the user selected for the customized product;
select a second dataset from a plurality of predetermined datasets that is similar to the first dataset;
transmit the second dataset with a unique user identification to a retargeting platform for display as a banner when the user visits a second website;
transmit a request to validate the first dataset to the retargeting platform;
receive the first dataset validated from the retargeting platform; and
transmit the first dataset with the unique user identification to the retargeting platform for display, as a banner, when the user visits the second website or other websites.

7. The computer program product of claim 6 wherein the instructions further cause the program to:
create a third dataset that is identical to the second dataset; and
transmit a request to validate the third dataset to the retargeting platform.

8. The computer program product of claim 6 wherein the third dataset is added to the plurality of predetermined datasets.

9. The computer program product of claim 6 wherein the first website and the second website are different.

10. The computer program product of claim 6 wherein the plurality of predetermined datasets are determined based on typical interactions within the first website.
